(19) United States
(12) Patent Application Publication
(10) Pub. No.: US 2023/0393278 A1
(43) Pub. Date: Dec. 7, 2023

(54) ELECTRONIC DEVICE, METHOD AND COMPUTER PROGRAM

(71) Applicant: Sony Semiconductor Solutions Corporation, Kanagawa (JP)

(72) Inventor: Valerio CAMBARERI, Stuttgart (DE)

(73) Assignee: Sony Semiconductor Solutions Corporation, Kanagawa (JP)

(21) Appl. No.: 18/034,423

(22) PCT Filed: Nov. 4, 2021
(86) PCT No.: PCT/EP2021/080662

§ 371 Date: Apr. 28, 2023

(30) Foreign Application Priority Data
Nov. 6, 2020 (EP) 20206307.9

(51) Int. Cl. G01S 17/894; G06T 7/50

(52) U.S. Cl. CPC G01S 17/894; G06T 7/50

(57) ABSTRACT

An electronic device comprising circuitry configured to unwrap a depth map or phase image by an artificial intelligence algorithm to obtain an unwrapped depth map is disclosed. A main input is subject to denoising to obtain a pre-processed main input, such as a pre-processed depth map. An artificial intelligence process, e.g. a convolutional neural network such as CNN has been trained to determine wrapping indexes from main input and side information data. This artificial intelligence process is performed on the pre-processed main input and pre-processed side information to obtain respective wrapping indexes. A postprocessing, such as an unwrapping algorithm is performed based on the wrapping indexes to obtain an unwrapped depth map. The U-Net architecture is used in a specific type of segmentation task, in which the boundaries are not dictated by objects but by passing unambiguous range boundaries.

### TECHNICAL FIELD

The present disclosure generally pertains to the field of Time-of-Flight imaging, and in particular, to device, methods and computer programs for Time-of-Flight image processing and unwrapping.

### TECHNICAL BACKGROUND

A Time-of-Flight (ToF) camera is a range imaging camera system that determines the distance of objects by measuring the time of flight of a light signal between the camera and the object for each point of the image. A Time-of-Flight camera thus generates a depth map of a scene. Generally, a Time-of-Flight camera has an illumination unit that illuminates a region of interest with modulated light, and a pixel array that collects light reflected from the same region of interest. That is, a Time-of-Flight imaging system is used for depth sensing or providing a distance measurement.

In indirect Time-of-Flight (iToF), three-dimensional (3D) images of a scene are captured by an iToF camera, which is also commonly referred to as “depth map”, wherein each pixel of the iToF camera is attributed with a respective depth measurement. The depth map can thus be determined directly from a phase image, which is the collection of all phase delays determined in the pixels of the iToF camera. This operational principle iToF measurements which is based on determine phase delays results in a distance ambiguity of iToF measurements.

Although there exist techniques for preventing distance ambiguity of Time-of-Flight cameras, it is generally desirable to provide better techniques for preventing distance ambiguity of a Time-of-Flight camera.

### SUMMARY

According to a first aspect the disclosure provides an electronic device comprising circuitry configured to unwrap a depth map or phase image by means of artificial intelligence to obtain an unwrapped depth map.

According to a second aspect the disclosure provides a method comprising unwrapping a depth map or phase image by means of artificial intelligence in order to obtain an unwrapped depth map. Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically shows the basic operational principle of a Time-of-Flight imaging system, which can be used for depth sensing or providing a distance measurement, wherein the ToF imaging system 1 is configured as an iToF camera;

FIG. 2 schematically illustrates in diagram this wrapping problem of iToF phase measurements;

FIG. 3 schematically shows an embodiment of a process of unwrapping iToF measurements based on artificial intelligence (AI) technology;

FIG. 4 shows in more detail an embodiment of a process of unwrapping iToF measurements;

FIG. 5 illustrates in more detail an embodiment of a process performed by the CNN 403, here implemented as a CNN of, for example, the U-Net type;

FIG. 6 shows another embodiment of the process of unwrapping iToF measurements described in FIG. 3, wherein U-Net is trained to generate wrapping indexes from iToF image training data and RGB image training data in order to unwrap a depth map generated by an iToF camera;

FIG. 7 shows another embodiment of the process of unwrapping iToF measurements described in FIG. 3, wherein a CNN is trained to generate an unwrapped depth map based on image training data;

FIG. 8 shows a flow diagram visualizing a method for unwrapping a depth map generated by an iToF camera based on wrapping indexes generated by a CNN;

FIG. 9 shows a flow diagram visualizing a method for training a neural network, such as the CNN described in FIG. 4, wherein LIDAR measurements are used to determine a true distance map for use as ground truth information;

FIG. 10 shows a flow diagram visualizing a method for training a neural network, such as the CNN described in FIG. 4, wherein iToF simulator measurements are used as ground truth information;

FIG. 11 schematically shows the location and orientation of a virtual iToF camera in a virtual scene;

FIG. 12 schematically describes an embodiment of an electronic device that can implement the processes of unwrapping iToF measurements;

FIG. 13 illustrates an example of a depth map captured by an iToF camera; and

FIG. 14 illustrates an example of different parts of a depth map used as an input to a neural network.

### DETAILED DESCRIPTION OF EMBODIMENTS

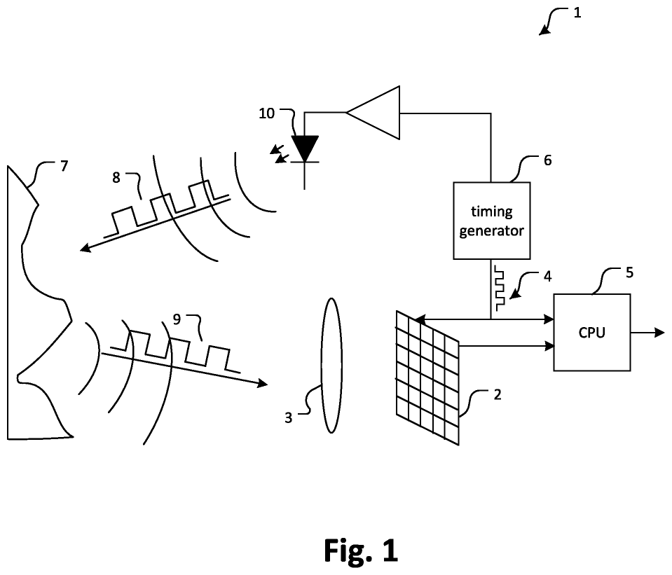

Before a detailed description of the embodiments under reference of FIG. 1 to FIG. 14, some general explanations are made.

The embodiments disclose an electronic device comprising circuitry configured to unwrap a depth map or phase image by means of an artificial intelligence (AI) algorithm to obtain an unwrapped depth map.

The circuitry of the electronic device may include a processor, may for example be CPU, a memory (RAM, ROM or the like), a memory and/or storage, interfaces, etc. Circuitry may comprise or may be connected with input means (mouse, keyboard, camera, etc.), output means (display (e.g. liquid crystal, (organic) light emitting diode, etc.)), a (wireless) interface, etc., as it is generally known for electronic devices (computers, smartphones, etc.). Moreover, circuitry may comprise or may be connected with sensors for sensing still images or video image data (image sensor, camera sensor, video sensor, etc.), for sensing environmental parameters (e.g. radar, humidity, light, temperature), etc.

The AI algorithm may be a data-driven (i.e., trainable) unwrapping algorithm, for example, a neural network, or any machine learning-based algorithm that represents a learned unwrapping function between the inputs and the output, or the like. The AI algorithm may be trained using an acquired dataset compatible or adapted to the use-cases, such as, for example, a dataset targeted to indoor or outdoor applications, industrial machine vision, navigation, or the like.

The wrapped depth map may be for example, a depth map wherein wrapping has distinctive patterns that correspond to sharp discontinuities in the phase image and which typically occur in the presence of slopes and objects (tilted walls or planes in indoor environments) whose depth extends over the unambiguous range.

The AI algorithm may be configured to determine wrapping indexes from the depth map or phase image in order to obtain an unwrapped depth map. For example, the artificial intelligence algorithm may learn from training data to recognize patterns that correspond to wrapping in phase images and to output a wrapping index and/or the unwrapped depth directly.

The circuitry may be configured to perform unwrapping based on the wrapping indexes and the unambiguous operating range of an indirect Time-of-Flight (iToF) camera to obtain the unwrapped depth map. In iToF cameras, a scene is illuminated with amplitude-modulated infrared light, and depth is measured by the phase delay of the return signal. The modulation frequency (or frequencies) of the iToF sensor may set the unambiguous operating range of the iToF camera.

The depth map or phase image may be obtained by an indirect Time-of-Flight (iToF) camera.

The AI algorithm may further use side-information to obtain an unwrapped depth map. In other words, the depth map may be used as the main input; as side-information, the AI algorithm may use the infrared amplitude of the iToF measurements, and/or the Red Green Blue (RGB) or other colorspace measurement of a captured scene, or processed versions of the latter (e.g., by segmentation or edge detection).

According to an embodiment, the side-information may be an amplitude image obtained by the iToF camera. For example, the amplitude image may comprise the infrared amplitude of an iToF camera that measures the return signal strength.

According to an embodiment, the side-information may be obtained by one or more other sensing modalities. The sensing modalities may be an iToF camera, and RGB camera, a grayscale camera, or the like.

According to an embodiment, the side-information may be a color image, such as for example, an RGB colorspace image and/or a grayscale image, or the like. For example, the RGB image and/or a grayscale image may be captured by a camera. The RGB image may be captured by an RGB camera and the grayscale image may be captured by a grayscale camera.

According to an embodiment, the pre-processing on the side information may comprise performing colorspace changes and image segmentation on the color image or applying contrast equalization to the amplitude image.

According to an embodiment, the side-information may be a processed version of an RGB image and/or a grayscale image. For example, the RGB image can be processed by means of edge detection or segmentation to enhance the detectability of object boundaries and/or object instances.

The electronic device may comprise an iToF camera. The iToF camera may comprise for example an iToF sensor or stacked sensors with iToF and hardware acceleration of neural network functions, or the like. The iToF sensor may use single frequency captures or may include a neural network acceleration close to the iToF sensor implemented in a smart sensor design. For example, the iToF sensor may operate at times its maximum N range, where N is the maximum allowed wrapping index in the algorithm, such as the iToF sensor may be operated at a high framerate, relying on an algorithm to perform the unwrapping rather than repeated captures.

The AI algorithm may be applied on a stream of depth maps and/or amplitude images and/or synchronized RGB images.

Additionally, as main inputs, the AI algorithm may receive a stream of one or more depth maps (frames) that correspond to one or more phase measurements per pixel, at one or more different frequencies. These are the main inputs of the algorithm which contain the patterns that can be learnt by the algorithm. During training, these patterns are matched against the unwrapped data, so that the data-driven algorithm can learn to perform the unwrapping by correlating the appearance of wrapped phase patterns and/or side-information patterns, such as object patterns and/or infrared amplitude patterns.

The circuitry may be further configured to perform pre-processing on the depth map or phase image. The circuitry may be further configured to perform pre-processing on the side information. The pre-processing may comprise segmentation, colorspace changes, denoising, normalization, filtering, and/or contrast enhancement, or the like. The pre-processing may use traditional and/or other AI algorithms to prepare the inputs of the AI algorithm, such as edge detection and segmentation.

According to an embodiment, the AI algorithm may be implemented as an artificial neural network. The artificial neural network may be a convolutional neural network (CNN). For example, the CNN may be of the U-Net type, or the like. The CNN may be trained using an acquired dataset compatible or adapted to a desirable use-case, such as a dataset that targets indoor or outdoor applications, industrial machine vision, indoor/outdoor navigation, autonomous driving, and the like. The artificial intelligence may be trained to learn “context”, such as object shapes and boundaries from side information, as well as context from depth, i.e., the morphological appearance of wrapped depth and the object boundaries appearing in side information.

According to an embodiment, the CNN may be of the U-Net type. Alternatively, the CNN may be itself a sequence of sub-networks, or the like.

According to an embodiment, the artificial intelligence may be trained with reference data obtained by a ground truth device, such as for example, precision laser scanners, or the like. The ground truth device may be a LIDAR scanner.

According to an embodiment, the artificial intelligence may be trained with reference data obtained by simulation of the iToF camera and the side-information used by the AI algorithm, such as the RGB image. The reference data may be synthetic data obtained by an iToF simulator.

The embodiments also disclose a method comprising unwrapping a depth map or phase image by means of artificial intelligence in order to obtain an unwrapped depth map.

Embodiments are now described by reference to the drawings.

### Operational principle of an indirect Time-of-Flight imaging system (iToF)

FIG. 1 schematically shows the basic operational principle of a Time-of-Flight imaging system, which can be used for depth sensing or providing a distance measurement, wherein the ToF imaging system 1 is configured as an iToF camera.

The ToF imaging system 1 captures three-dimensional (3D) images of a scene 7 by analysing the time of flight of infrared light emitted from an illumination unit 10 to the scene 7. The ToF imaging system 1 includes an iToF camera, for instance the imaging sensor 2 and a processor (CPU) 5. The scene 7 is actively illuminated with amplitude-modulated infrared light 8 at a predetermined wave-length using the illumination unit 10, for instance with some light pulses of at least one predetermined modulation frequency generated by a timing generator 6. The amplitude-modulated infrared light 8 is reflected from objects within the scene 7. A lens 3 collects the reflected light 9 and forms an image of the objects onto an imaging sensor 2, having a matrix of pixels, of the iToF camera. Depending on the distance of objects from the camera, a delay is experienced between the emission of the modulated light 8, e.g. the so-called light pulses, and the reception of the reflected light 9 at each pixel of the camera sensor. Distance between reflecting objects and the camera may be determined as function of the time delay observed and the speed of light constant value.

A three-dimensional (3D) images of a scene 7 captured by an iToF camera is also commonly referred to as “depth map”. In a depth map, each pixel of the iToF camera is attributed with a respective depth measurement.

In indirect Time-of-Flight (iToF), for each pixel, a phase delay between the modulated light 8 and the reflected light 9 is determined by sampling a correlation wave between the demodulation signal 4 generated by the timing generator 6 and the reflected light 9 that is captured by the imaging sensor 2. The phase delay is proportional to the object's distance modulo the wavelength of the modulation frequency. The depth map can thus be determined directly from the phase image, which is the collection of all phase delays determined in the pixels of the iToF camera.

### The “Wrapping” Problem

This operational principle iToF measurements which is based on determine phase delays results in a distance ambiguity of iToF measurements. A phase measurement produced by the iToF camera is “wrapped” into a fixed interval, i.e., [0,2π], such that all phase values corresponding to a set {Φ|Φ=2kπ+φ, k∈Z} become φ, where k is called “wrapping index”. In terms of depth measurement, all depths are wrapped into an interval that is defined by the modulation frequency. In other words, the modulation frequency sets an unambiguous operating range

$$Unambiguous Range = \frac{Speed of Light}{2 \times Modulation Frequency}$$

For example, for an iToF camera having a modulation frequency 20 MHz, the unambiguous range is 7.5 m.

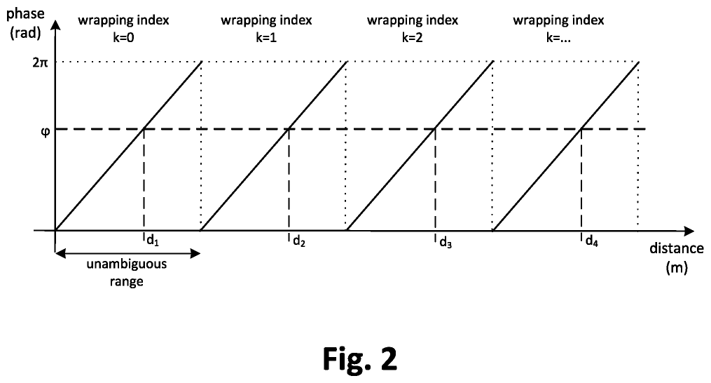

FIG. 2 schematically illustrates in diagram this wrapping problem of iToF phase measurements. The abscissa of the diagram represents the distance (true depth) between an iToF pixel and an object in the scene, and the ordinate represents the respective phase measurements obtained for the distances. In FIG. 2, the horizontal dotted line represents the maximum value of the phase measurement, 2π, and the horizontal dashed line represents an exemplary phase measurement value φ. The vertical dashed lines represent different distances d₁, d₂, d₃, d₄ that correspond to the exemplary phase measurement φ due to the wrapping problem. Thereby, any one of the distances d₁, d₂, d₃, d₄ corresponds to the same value of φ. The distance d₁ can be attributed to a wrapping index k=0, the distance d₂ can be attributed to a wrapping index k=1, the distance d₃ can be attributed to a wrapping index k=2, and so on. The unambiguous range defined by the modulation frequency is indicated in FIG. 2 by a double arrow.

### Resolving the “Wrapping” Problem

The ambiguity concerning the wrapping indexes can be resolved by inferring the correct wrapping index for each pixel from other information. This process of resolving the ambiguity is called “un-wrapping”.

The existing methodologies use more than one frequency and extend the unambiguous range by lowering the effective modulation frequency, for example, using the Chinese Remainder Theorem (NCR Theorem), as described also in published paper A. P. P. Jongenelen, D. G. Bailey, A. D. Payne, A. A. Dorrington, and D. A. Carnegie, “Analysis of Errors in ToF Range Imaging With Dual-Frequency Modulation,” IEEE Transactions on Instrumentation and Measurement, vol. 60, no. 5, pp. 1861-1868, May 2011. Multi-frequency captures, however, are slow as they require the acquisition of the same scene over several frames, therefore they are subjected to motion artefacts, and thus, limit the frame rate and motion robustness of iToF sensors, especially in case where the camera, the subject/object, the foreground or the background move during the acquisition.

In a case of dual frequency measurements, for example, a pair of frequencies such as 40 MHz and 60 MHz are used to resolve the effective frequency of 20 MHz=GreatestCommonDivisor(40 MHz, 60 MHz), which corresponds to an effective unambiguous range of 7.5 m. The unwrapping algorithm, in the dual frequency approaches, is straightforward and computationally lightweight, so that it can run real-time. This NCR algorithm operates per-pixel, without using any spatial priors, therefore, it does not leverage the recognition of features/patterns in the depth map and/or side-information, and thus, the NCR algorithm cannot unwrap beyond the unambiguous range.

There are other techniques for resolving the distance ambiguity, for example the neighboring pixels in the depth map can be used as other information, or the like. Such techniques leverage spatial priors, in that they enforce the spatial continuity of the wrapping indexes that correspond to connected regions of pixels. For example, they leverage the continuity of wrapping indexes for the same object, or the same boundary in the phase image.

In addition, the presence of noise may make more difficult to disambiguate between wrapping indexes, as the true depth may correspond to more than one wrapping index, as described above.

### “Unwrapping” by Machine Learning

According to the embodiments described below in more detail, to address the “wrapping” ambiguity, the mapping of iToF depth maps to respective wrapping index configurations is learnt by machine learning, such as for example, by a neural network. The thus trained artificial intelligence (AI) is then used to “unwrap” iToF depth maps, i.e., to resolve the phase ambiguity to at least some extent.

The artificial intelligence can also learn to resolve the phase ambiguity in the presence of noise to at least some extent.

For any true depth in the observed scene, there exists an unambiguous range at which

$$Measured Depth = ( True Depth + Measured Bias + Depth Noise ) mod Unambiguous Range$$

This is an instance of a system in which the acquisition is defined modulo a certain physical quantity which, in this case, it is the unambiguous range.

According to the embodiments below, an artificial intelligence (AI), i.e., system and software-level strategy, generates an unwrapped depth that corresponds approximately to the true depth:
Unwrapped Depth≈True Depth

Where we obtain unwrapped depth by means of AI. For example, the unwrapped depth may be obtained as

Unwrapped Depth=Measured Depth+Wrapping Index×Unambiguous Range

Where the main information required for unwrapping, i.e., the

Wrapping Index=Unwrapping Algorithm(Measured Depth, Prior Information).

In other words, by means of artificial intelligence (AI) such as a neural network, the operational range of the iToF camera can be extended beyond the unambiguous range set by the modulation frequency (or frequencies) by determining the wrapping indexes for unwrapping the depth maps generated by the iToF camera given all the available information, i.e., what we define main inputs as obtained from the iToF camera, and what we define side-information.

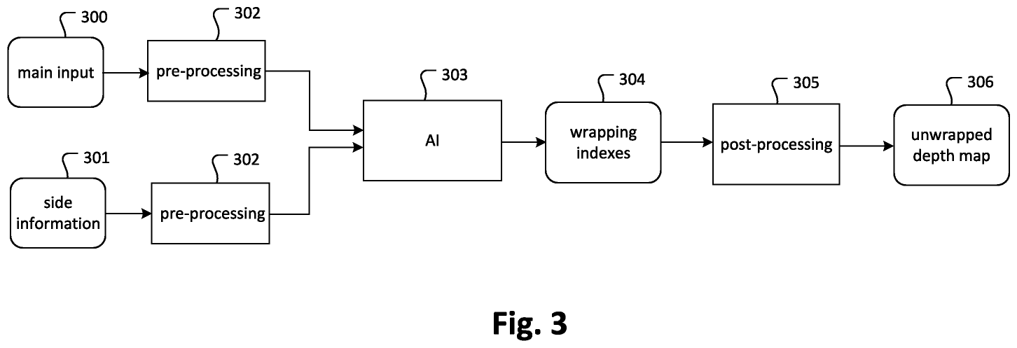

The depth map can be considered as a main input (see 300 in FIG. 3 below) to such a neural network. Additionally, other information (see 301 in FIG. 3 below) can be input to the neural network (see 303 in FIG. 3 below) as side-information for improving the precision of the unwrapping algorithm. This side-information will typically not be affected by wrapping in the same fashion as the main inputs.

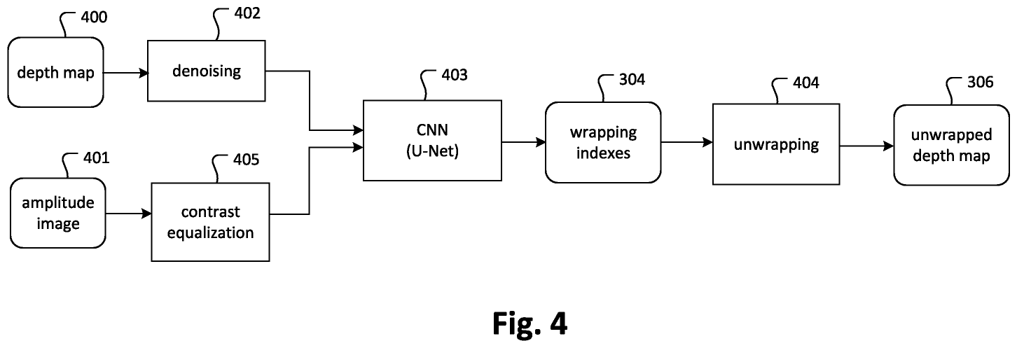

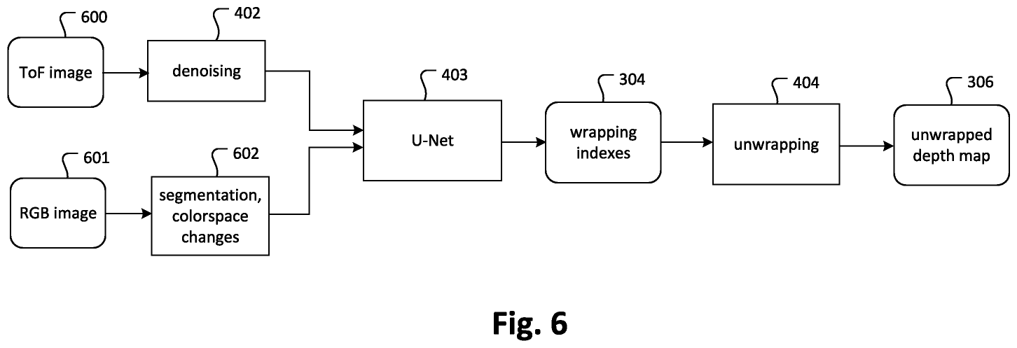

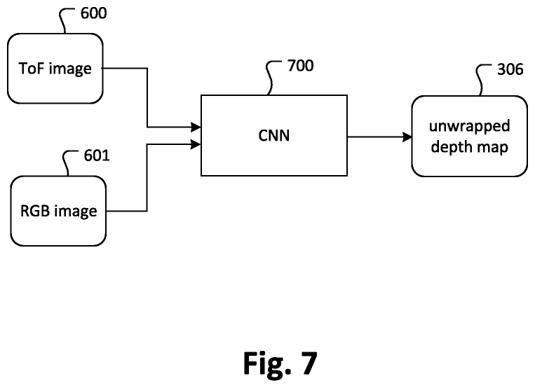

For example, side-information can be supplied to the algorithm, such as: RGB images obtained from an RGB camera (see embodiments of FIGS. 6 and 7); grayscale images resulting from other sensing modalities; infrared amplitude (see embodiment of FIG. 4) that the iToF sensor records per-pixel. For example, for a fixed material at the illuminated scene, the infrared amplitude decays with distance as the inverse square law and has therefore embedded in its value a dependency on the unwrapped depth.

For example, pre-processed versions of the side-information images can be supplied to the algorithm, such as the result of an edge detection or segmentation algorithm.

An algorithm capable of leveraging this additional side information may resolve distances beyond the unambiguous range, by performing unwrapping based on wrapped depth maps and side-information.

FIG. 3 schematically shows an embodiment of a process of unwrapping iToF measurements based on artificial intelligence (Al) technology. The process allows to apply artificial intelligence technology on a depth map generated by an iToF camera in order to unwrap the generated depth map.

A main input 300 is subjected to a pre-processing 302 (such as denoising 402 in FIG. 4 and corresponding description) to obtain a pre-processed main input, such as a pre-processed depth map. The main input 300 comprises for example, a stream of one or more iToF depth maps or phase images, e.g. frames, which correspond to one or more phase measurements per pixel, at one or more different frequencies.

Similarly, side information 301 is subjected to a pre-processing 302 such as segmentation and/or colorspace-changes (405 in FIG. 4), or contrast equalization (602 in FIG. 6) to obtain pre-processed side information. The side information 301 comprises for example infrared amplitudes of the iToF measurements (such as described in FIG. 4 and corresponding description) and/or an RGB image of a captured scene (such as described in FIG. 6 and corresponding description).

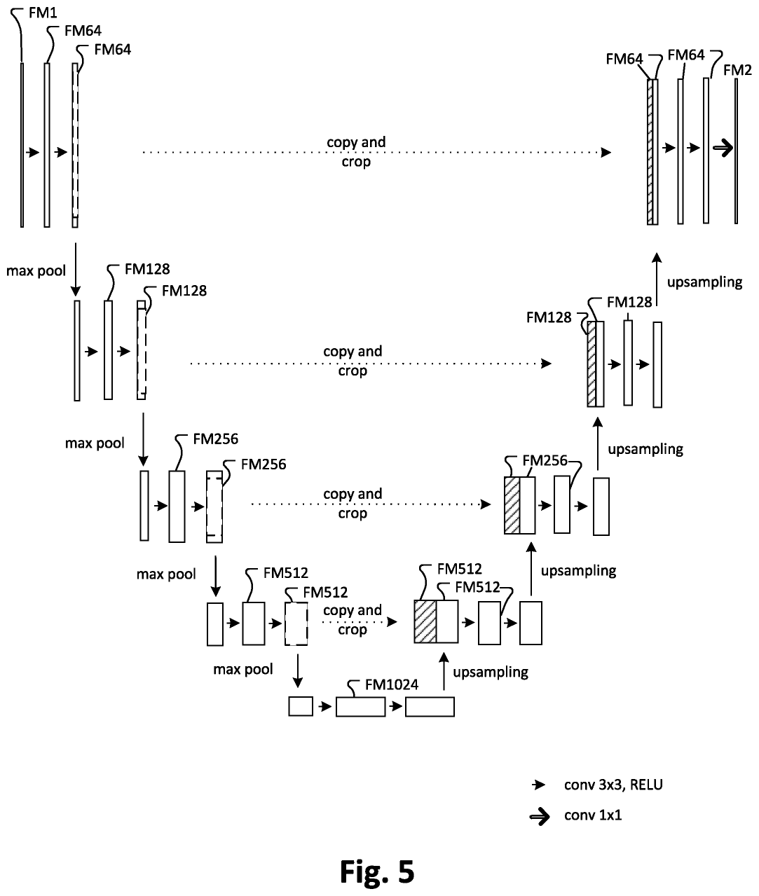

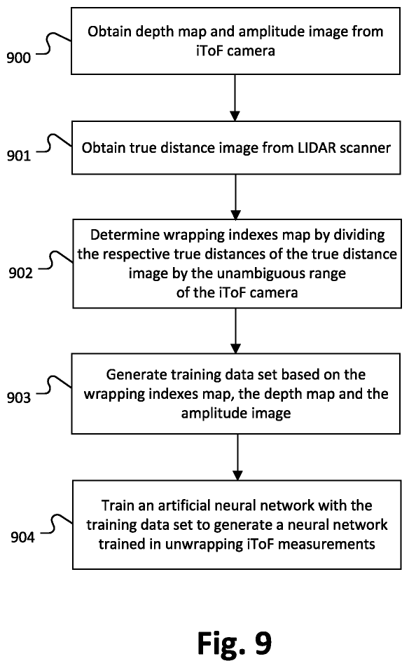

An artificial intelligence process 303 (e.g. a CNN such as CNN 403 shown in FIG. 5 and corresponding description) has been trained (see FIGS. 9, 10 and 11 and corresponding description) to determine wrapping indexes from main input and side information data. This artificial intelligence process 303 is performed on the pre-processed main input and the pre-processed side information to obtain respective wrapping indexes 304. A post-processing 305 (such as an unwrapping algorithm 404 as shown in FIG. 4 and corresponding description) is performed based on the wrapping indexes 304 to obtain an unwrapped depth map 306.

In the embodiment of FIG. 3, the main input 300 and the side information 301 are subjected to a pre-processing 302 before being input to the artificial intelligence process 303, such as segmentation, colorspace changes, denoising, normalization, filtering, contrast enhancement, or the like. However, the pre-processing 302 is optional, and alternatively, the artificial intelligence process 303 may be directly performed on the main input 300 and the side information 301.

The suitable wrapping indexes, and thus, the desired unwrapped depth map, are generated by leveraging phase image features e.g. patterns corresponding to wrapping errors in the phase measurements, and the recognition of such features is performed based on machine learning, such as convolutional neural networks (see FIGS. 3, 4, 6 and 7 and the corresponding description).

For example, a convolutional neural network (CNN) of the U-Net type (see FIG. 5), which describes the general features of a CNN such as the max-pooling, the upsampling, the convolution, the ReLU, and so on, may be used as machine learning, without limiting the present invention in that regard.

Alternatively, any machine learning-based algorithm (e.g. an AI algorithm) that represents a learned unwrapping function between the inputs and the output, may be used. Still alternatively, the artificial neural network may be a U-Net with any neural network, with another-Net, or the like.

FIG. 4 shows in more detail an embodiment of a process of unwrapping iToF measurements.

A depth map 400, which is used as main input (see 300 in FIG. 3), is subjected to denoising 402 to obtain a denoised depth map. The denoising 402, which may be a bilateral filtering, an anisotropic diffusion or the like, is described in more detail further below. Similarly, an amplitude image 401, which is used as side information (see 301 in FIG. 3), is subjected to contrast equalization 405 to obtain a contrast equalized amplitude image.

The depth map 400 is an image or an image channel that contains information relating to the true distance of the surfaces of objects in a scene (see 7 in FIG. 1) from a viewpoint, i.e. from an iToF camera. The distance is

$$d = \frac{c}{4 π f} φ$$

where c is the speed of light constant, f is the modulation frequency of the iToF camera and φ∈[0, 2π) is the phase delay of the reflection signal.

Therefore, the depth (distance) is here measured by the phase delay of the return signal, i.e., modulo the unambiguous range

$${d}_{max} = \frac{c}{2 f}$$

The depth map can thus be determined directly from a phase image, which is the collection of all phase delays determined in the pixels of the iToF camera.

In other words, the phase delay gyp, which is proportional to the object's distance to the iToF camera, is given by:

$$φ = arctan ( \frac{{Q}_{3} - {Q}_{4}}{{Q}_{1} - {Q}_{2}} )$$

where Q₁, Q₂, Q₃, Q₄ are four samples (measurements) of the correlation waveform of the reflected signal having each sample a phase-step of 90°.

The amplitude image 401 contains for example the reflected light corresponding to the generated depth map and {x,y,z} coordinates, which correspond to each pixel in the depth map. The amplitude image is encoded with the strength of the reflected signal, and the reflected amplitude A is:

$$A = \frac{\sqrt{{( {Q}_{1} - {Q}_{2} )}^{2} + {( {Q}_{3} - {Q}_{4} )}^{2}}}{2}$$

For example, for a fixed material at the illuminated scene, the infrared amplitude A will typically decay with distance d as the inverse square law

$$( i . e . , A ∝ \frac{1}{{d}^{2}} )$$

and has therefore embedded in its value a dependency on the unwrapped depth.

A CNN 403 of the U-Net type (see FIG. 5 and corresponding description) has been trained (see FIGS. 9, 10 and 11 and corresponding description) to determine wrapping indexes 304 from the depth map 400 and the amplitude image 401. This CNN 403 is applied on the denoised depth map image and the denoised amplitude image to obtain respective wrapping indexes 304. An unwrapping process 404 is performed on the wrapping indexes 304 to obtain an unwrapped depth map 306.

The wrapping indexes 304 generated by the CNN 403 are given by

Wrapping Index=ConvolutionalNeuralNetwork(Measured Depth, Measured Amplitude, Learned Parameters)

The unwrapping algorithm 404 is used to compute the unwrapped depth map 306 based on the wrapping indexes 304:

Unwrapped Depth=UnwrappingAlgorithm(Measured Depth, Side Information, Learned Parameters).

In the present embodiment the unwrapped depth may be directly obtained by

Unwrapped Dept=Measured Depth+Wrapping Index×Unambiguous Range.

In the embodiment of FIG. 4, the depth map 400 is subjected to denoising 402, such as bilateral filtering or anisotropic diffusion, and the amplitude image 401 is subjected to contrast equalization 405 before being input to the CNN 403, such that a denoised depth map and a contrast equalized amplitude image to be the inputs of the CNN 403, without limiting the present embodiment in that regard. Alternatively, the amplitude image 401 may be subjected to segmentation. This preprocessing is optional. Alternatively, the inputs of the CNN 403 may be the depth map 400 and the amplitude image 401.

In the embodiment of FIG. 4, a depth map 400 is used as main input for the CNN of the U-Net type. However, the embodiments are not restricted to this example. Alternatively, phase images or similar information may be used as main input for the U-Net.

Still further, in the embodiment of FIG. 4 a CNN of the U-Net type is used as system/software architecture implementing the artificial intelligence (AI). In alternative embodiments, other machine learning architectures can be used.

### Convolutional Neural Network of the U-Net Type

By determining the map of wrapping indexes, an iToF image is segmented into different regions with the same wrapping index. In other words, the task solved by the CNN is to determine the wrapping indexes in a fashion similar to image segmentation. Alternatively, an RGB or an amplitude image segmentation may be used as a guide to help determine the wrapping indexes.

FIG. 5 illustrates in more detail an embodiment of a process performed by the CNN 403, here implemented, for example, as a CNN of the U-Net type. The CNN of the U-Net type is configured to obtain wrapping indexes 304 as described in more detail in FIGS. 3 and 4 above.

The U-Net architecture is a fully convolutional network, i.e., the network layers are comprised of linear convolutional filters followed by non-linear activation functions. U-Nets were developed for use in image segmentation. The U-Net architecture is here used in a specific type of segmentation task, in which the boundaries are not dictated by objects but by passing unambiguous range boundaries.

The U-Net architecture is for example described in “U-Net: Convolutional Networks for Biomedical Image Segmentation”, Olaf Ronneberger, Philipp Fischer, and Thomas Brox, arXiv:1505.04597v1 [cs.CV], 18 May 2015. The U-Net architecture consists of a contracting “encoder” path (left side of FIG. 5) to capture context and an expanding “decoder” path (right side of FIG. 5), which may be symmetric to the encoder path. Both the encoder path and the decoder path consist of multi-channel feature maps, which in FIG. 5 are represented by white boxes. The patterned boxes in the decoder path indicate additional feature maps that have been copied (i.e., “concatenation”). As the decoder path is symmetric to the encoder path it yields a U-shaped architecture.

The encoder path follows the typical architecture of a convolutional neural network, consisting of a repeated application of convolution layers(unpadded convolutions), each followed by a rectified linear unit (ReLU), represented by horizontal solid arrows (left side of FIG. 5); a max-pooling operation is used for downsampling, represented by downward vertical arrows (left side of FIG. 5).

Each multi-channel feature map comprises multiple feature channels. At each downsampling step (by max-pooling) the number of feature channels is doubled. In the example of FIG. 5, the upper layer of the encoder path comprises features blocks FM64, each comprising 64 feature channels, the next layer of the encoder path comprises features blocks FM128, each comprising 128 feature channels, the next layer of the encoder path comprises features blocks FM256, each comprising 256 feature channels, the next layer of the encoder path comprises features blocks FM512, each comprising 512 feature channels, and the lowest layer of the encoder path comprises features blocks FM1024, each comprising 1024 feature channels.

The unpadded convolutions crop away some of the borders if a kernel is larger than 1 (see dashed boxes in encoder path). The kernel, which is a small matrix, is used, for example, for blurring, sharpening, edge detection, and the like, by applying a convolution between a kernel and an image. A kernel size defines the field of view of the convolution and the stride defines the step size of a kernel when traversing the image.

The horizontal dotted arrows, which extend from the encoder path to the decoder path represent a copy and crop operation of the U-Net. That is, each dashed box of the encoder path is cropped and copied to the decoder path such as to form a respective patterned box.

The expansive path consists of a repeated application of an upsampling operation of the multi-channel feature map, represented by upward vertical arrows (right side of FIG. 5), which halves the number of feature channels, a concatenation with the correspondingly cropped feature map from the encoder path, and two convolution layers, each followed by a ReLU (horizontal arrows).

At each upsampling step the number of feature channels is halved. In the example of FIG. 5, the lowest layer of the encoder path comprises features blocks FM1024, each comprising 1024 feature channels, and they are halved, such that the lowest layer of the decoder path comprises features blocks FM512 (white boxes), each comprising 512 feature channels. The dashed boxes of the encoder path are cropped and copied (dotted arrow), such as to form the features blocks FM512 (patterned boxes) of the decoder path, each comprising 512 feature channels. The white box FM512 together with the patterned box FM512 comprise the same number of feature channels as the previous layer, that is, 1024 feature channels. Then, 3×3 convolutions, each followed by a ReLU (horizontal arrows) are applied on the white box FM512. Accordingly, the next layer of the decoder path comprises features blocks FM256 (white boxes and patterned boxes), each comprising 256 feature channels, the next layer of the decoder path comprises features blocks FM128 (white boxes and patterned boxes), each comprising 128 feature channels, and the upper layer of the decoder path comprises features blocks FM64 (white boxes and patterned boxes), each comprising 64 feature channels.

At each downsampling step of the encoder path and at each upsampling step of the decoder path, a respective convolution operation is performed using convolutional filters of different size. The size of the convolutional filters may be 2×2, 3×3, 5×5, 7×7, and the like. In general, the number of feature maps in the inner layers is set by the number of learned convolutional filters per layer.

At the upper layer of the encoder path, a feature map FM1 comprising 1 feature channel (e.g., a grayscale image or an amplitude image), is used as input to the U-Net. At the upper layer of the decoder path, a 1×1 convolution (double line arrow) is applied on the last feature block FM64 (white box) to map each 64-component feature vector to the desired number of classes i.e. output segmentation map FM2. Here, the output segmentation map FM2 has two channels which corresponds to two classes.

This exemplifying description of a U-Net can be adapted to the CNNs trained to perform unwrapping as described in the embodiments above.

As generally known by the skilled person, the input feature maps are typically fixed by the number of inputs of the use case. The convolutional neural network (CNN) of the U-Net type applied in the embodiment of FIG. 4 has as inputs a depth map and an infrared amplitude image which are both obtained with the same iToF sensor and thus have identical resolution. The infrared amplitude image leads to grayscale values, thus, having only one channel. The depth information and the amplitude information can thus be seen as two channels of a single input image, so that there is one feature maps FM2 with two channels in the upper layer of the encoder path. The desired number of classes on the output side of the U-Net may be chosen according to the number of wrapping indexes comprised in the learning data. For example, in a case where the desired number of classes, i.e., the number of wrapping indexes, is six, the resulting segmentation map FM6 has six channels.

For example, a SoftMax layer, which converts the six-channel feature map for six wrapping indexes in respective class probabilities. For example, at a certain pixel of the output segmentation map, the output may be (0.01, 0.04, 0.05, 0.7, 0.1, 0.1) which—in the training phase—is compared to the ground truth label (three in this case, counting from 0) using an appropriate loss function, e.g., the so-called “sparse categorical crossentropy”.

In the example of FIG. 6 the convolutional neural network (CNN) of the U-Net type has as inputs a depth map and an RGB image which are obtained with an iToF sensor and an RGB camera sensor that can be registered to have the same resolution. For example, the RGB image can be registered to the same reference frame as the iToF image, or the alignment between the RGB image and the iToF image can be computed, or the RGB camera sensor can be co-located with the iToF sensor. The depth information and the RGB information can thus be seen as two input images, so that there result one feature map FM1 with one channel (depth information) and a second feature map FM3 with three channels (RGB information) in the upper layer of the encoder path.

The embodiments are not restricted to those given above (Depth+IR: 1+1 channels, and Depth+RGB: 1+3 channels) and the skilled person can foresee modifications. For example, in addition to an iToF depth map obtained from an iToF sensor as main input, an amplitude image (IR) obtained from the iToF sensor and RGB image obtained from an external RGB camera can be used as side information (Depth+RGB+IR: 1+3+1 channels), if for example an infrared amplitude and an RGB image are added to the input stack. Other input stacks may comprise RGB+Depth (frequency 1)+Depth (frequency 2)+IR, or the like.

### Pre-Segmentation of Side Information

It was described above (see 302 in FIG. 3) that pre-processing steps may be performed on the depth image and/or on the side information (RGB image, etc.). One possibility for such preprocessing is image segmentation (see 405 in FIG. 4).

As already described in FIG. 3 above, side information (see 301), such as a grayscale image and/or an RGB image (see 601 in FIG. 6), are subjected to pre-processing (see 302), such as contrast equalization and image segmentation (see 405 in FIGS. 4 and 602 in FIG. 6), to obtain a processed version of a grayscale image and/or an RGB image respectively. That is, the RGB image may be processed by means of for example edge detection or image segmentation to enhance the detectability of object boundaries and/or object instances.

The preprocessed side information may replace the original side information in the input stack, or additional information obtained from the preprocessing (e.g., object boundaries, segmentation map) may be added to the input stack of the CNN as side information.

Any known object recognition methods may be used to implement the preprocessing (algorithmic, CNN, . . . ). For example, U-Nets are used in a specific type of image segmentation in which the boundaries are not dictated by objects but by passing unambiguous range boundaries.

### Colorspace Changes

A further possibility for pre-processing (see 302 in FIG. 3) of side information is colorspace changes (see 405 in FIG. 4). A color space is a specific organization of colors, which may be arbitrary, i.e. with physically realized colors, assigned to a set of physical color swatches with corresponding assigned color names, or structured with mathematical rigor, such as the NCS System, Adobe RGB, sRGB, and the like. Color space conversion is the translation of the representation of a color from one basis to another. Typically, this occurs in the context of converting an image that is represented in one color space, such as RGB colorspace, to another color space, such as grayscale colorspace, the goal being to make the translated image look as similar as possible to the original.

As already described in FIG. 3 above, side information (see 301), such as RGB image (see 601 in FIG. 6), are subjected to pre-processing (see 302), such as colorspace changes (see 602 in FIG. 6), to obtain a processed version of an RGB image. That is, the RGB image may be processed by means of colorspace conversion to obtain an image of another colorspace, such as for example, the grayscale colorspace. Therefore, an image of one feature channel, such as the grayscale image, may be used as an input to the neural network of U-Net type (see 403 in FIG. 4) instead of using an image of multiple feature channels, such as for example the RGB image, and thus, having a more suitable input for the neural network.

The various color spaces exist because they present color information in ways that make certain calculations more convenient or because they provide a way to identify colors that is more intuitive. For example, the RGB color space defines a color as the percentages of red, green, and blue hues mixed together.

### Denoising

A still further possibility for pre-processing (see 302 in FIG. 3) is denoising of the depth map (see 402 in FIG. 4). In the embodiment of FIG. 4, denoising 402 is performed on the depth map 400, to obtain denoised data. Any denoising algorithm known to the skilled person may be used for this purpose. An exemplary denoising algorithm is a bilateral filter, such as described by C. Tomasi and R. Manduchi in the published paper “Bilateral Filtering for Gray and Color Images”, Sixth International Conference on Computer Vision (IEEE Cat. No.98CH36271), Bombay, 1998, pp. 839-846, doi: 10.1109/ICCV.1998.710815.

A bilateral filter is a non-linear smoothing filter that performs fast edge-preserving image denoising. The bilateral filter replaces the value at each pixel with a weighted average of the values of nearby pixels. This weighted average is typically performed with Gaussian weights that depend on the Euclidean distance of pixels' coordinates, and on the pixel values' difference; in the case of depth denoising, that difference is taken in amplitude, depth, or phasor domain. This denoising process helps to preserve sharp edges.

The bilateral filter reads

$${I}^{filtered} ( x ) = \frac{1}{{W}_{p}} {\sum }_{{x}_{i} ∈ Ω} I ( {x}_{i} ) {f}_{r} ( ‖ I ( {x}_{i} ) - I ( x ) ‖ ) {g}_{s} ( ‖ {x}_{i} - x ‖ )$$

where Wₚ is a normalization term, and

$${W}_{p} = {\sum }_{{x}_{i} ∈ Ω} {f}_{r} ( ‖ I ( {x}_{i} ) - I ( x ) ‖ ) {g}_{s} ( ‖ {x}_{i} - x ‖ )$$

I^{filtered} is the filtered image (here the denoised version of the depth image 400), I the original input image to be filtered (here the depth image 400), x denotes the coordinates of the current pixel to be filtered, Ω is the window centered in x, so that xᵢ E∈Ω is another pixel, fᵣ is the range kernel for smoothing in values domain (e.g., depth, amplitude, phasors), and gₛ is the spatial kernel for smoothing in coordinates domain.

Another exemplary denoising algorithm is described by Frank Lenzen, Kwang In Kim, Henrik Schafer, Rahul Nair, Stephan Meister, Florian Becker, Christoph S. Garbe, Christian Theobalt in the published paper “Denoising Strategies for Time-of-Flight Data”, In M. Grzegorzek, C. Theobalt, R. Koch, A. Kolb (eds.), Time-of-Flight and Depth Imaging: Sensors, Algorithms, and Applications, LNCS 8200, pp. 25-45, Springer, Sep. 11, 2013

Alternatively, pre-processing can be applied as contrast equalization to the infrared amplitude image (see 401 in FIG. 4), or the like.

### Modifications

FIG. 6 shows another embodiment of the process of unwrapping iToF measurements described in FIG. 3, wherein U-Net is trained to generate wrapping indexes (see 304 in FIG. 3) from iToF image data and RGB image data in order to unwrap a depth map generated by an iToF camera.

A ToF image 600, which is an iToF image such as a depth map and is used as main input (see 300 in FIG. 3), is subjected to denoising 402 to obtain a denoised iToF image. The iToF image 400 is a three-dimensional (3D) image of a scene (see 7 in FIG. 1) captured by an iToF camera, which is also commonly referred to as “depth map” that corresponds to a phase measurement per pixel, at one or more different frequencies.

Similarly, an RGB image 601, which is used as side information (see 301 in FIG. 3), is subjected to image segmentation/colorspace changes 602 to obtain a preprocessed image. The RGB image is a color channel image having red, green and blue color channels. The RGB image comprises RGB image data represented by a specific number of color channels, in which multiple spectral channels are integrated.

A CNN 403 (see FIG. 5 and corresponding description) has been trained (see FIGS. 9, 10 and 11 and corresponding description) to determine wrapping indexes 304 from iToF image data and RGB image data. This CNN 403 is applied on the denoised iToF image and the denoised RGB image to obtain respective wrapping indexes 304. An unwrapping 404 process is performed on the wrapping indexes 304 to obtain an unwrapped depth map 306.

In the embodiment of FIG. 6, the RGB image 601 is used as side information (see 301 in FIG. 3), without liming the present invention to that regard. Alternatively, any color image, and thus, different colorspaces, may be used as side information. Further alternatively, grayscale images resulting from other sensing modalities may be used as side information. The iToF image 600 is subjected to denoising 402, such as bilateral filtering or anisotropic diffusion, and the RGB image 601 is subjected to image segmentation/colorspace changes 602 before being input to the CNN 403. The denoising 402 of the iToF image and the image segmentation/colorspace changes 602 of the RGB image, the CNN 403 and the unwrapping process 404 can for example be implemented, as described above. However, the denoising 402 and the image segmentation/colorspace changes 602 are optional, and alternatively, the input of the CNN 403 may be directly the iToF image 600 and the RGB image 601.

FIG. 7 shows another embodiment of the process of unwrapping iToF measurements described in FIG. 3, wherein a CNN is trained to generate an unwrapped depth map based on image training data.

A ToF image 600 is input as iToF image training data to a CNN 700. The ToF image 600 includes for example one or more depth maps (frames) that correspond to one or more phase measurements per pixel, at one or more different frequencies.

Similarly, an RGB image 601 is input as RGB image training data to the CNN 700. The RGB image 601 is a color channel image having red, green and blue color channels. The RGB image 601 comprises RGB image data represented by a specific number of color channels, in which multiple spectral channels are integrated.

The CNN 700 has been trained (see FIGS. 9, 10 and 11 and corresponding description) to determine wrapping indexes 304 (see FIG. 3) from iToF image data and RGB image data. This CNN 700 is applied on the iToF image 600 and the RGB image 601 to generate respective wrapping indexes 304 and to perform unwrapping based on the wrapping indexes 304 in order to obtain an unwrapped depth map 306. The CNN 700 can for example implement the process of the CNN 403 of U-Net type and the unwrapping process 404, as described with regard to FIG. 4 above.

### Method

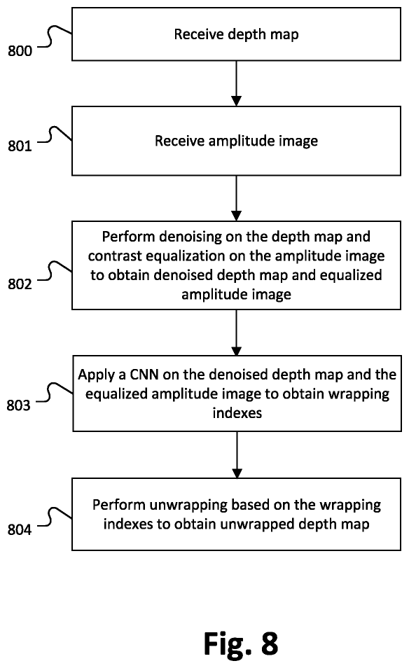

FIG. 8 shows a flow diagram visualizing a method for unwrapping a depth map generated by an iToF camera based on wrapping indexes generated by a CNN. At 800, a pre-processing 302 (see FIG. 3), such as the denoising 402 (see FIG. 4), receives a main input 300 (see FIG. 3), such as the depth map 400 (see FIG. 4). At 801, the pre-processing 302 (see FIG. 3), such as the contrast equalization 405 (see FIG. 4), receives a side information 301 (see FIG. 3), such as the amplitude image 401 (see FIG. 4). At 802, the denoising 402 (see FIG. 4) performs denoising on the depth map 400 (see FIG. 4) and the contrast equalization 405 is performed on the amplitude image 401 (see FIG. 4) to obtain a denoised depth map and a contrast-equalized amplitude image. At 803, a convolutional neural network, such as the CNN 403 (see FIG. 4), is applied on the denoised depth map and the contrast-equalized amplitude image to obtain wrapping indexes 304 (see FIGS. 3, 4 and 6). At 804, a post-processing 305 (see FIG. 3), such as the unwrapping 404 (see FIGS. 4 and 6), is performed based on the wrapping indexes 304 to obtain an unwrapped depth map 306 (see FIGS. 3, 4 and 6).

### Training

During training, a CNN adjusts its weight parameters to the available training data, i.e., in the embodiments described above, to several pairs of input data (phase images, and amplitude images as obtained from iToF camera) and output data (wrapping indexes).

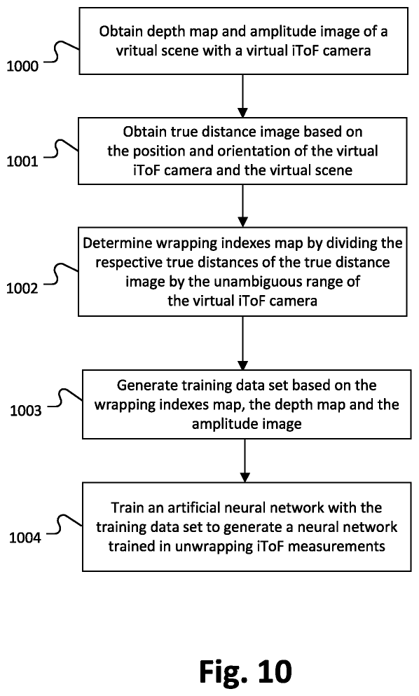

These pairs can be either synthetic data obtained by a Time-of-Flight simulator (see FIG. 10), or real data acquired by a combination of iToF cameras and ground truth devices (e.g., precision laser scanners, LiDAR, or the like) with annotation of the wrapping index 304 obtained by processing the ground truth (see FIG. 9). During training the weight parameters of the CNN are adapted to the morphology of the training data. The CNN learns to extract the features from the training data that correspond to wrapping regions, and it learns to map them to changes in the respective wrapping indexes.

FIG. 9 shows a flow diagram visualizing a method for training a neural network, such as the CNN 403 described in FIG. 4, wherein LIDAR measurements are used. As described in the embodiments herein, the CNN 403 is applied on a denoised depth map and a denoised amplitude image to generate wrapping indexes 304 (see FIGS. 3, 4 and 6). The CNN 403, in order to generate the wrapping indexes 304, is trained in unwrapping iToF measurements, such that at 900, a depth map (see 400 in FIG. 4) and an amplitude image (see 401 in FIG. 4) from an iToF camera are first obtained, and then a true distance image from a LIDAR scanner are obtained at 901, in order to determine, at 902, a wrapping indexes map (see 304 in FIGS. 3 and 4) by dividing the respective true distances of the true distance image by the unambiguous range of the iToF camera. The unambiguous range of the iToF camera is set based on the modulation frequency of the iToF camera as described above. At 903, a training data set is generated based on the determined wrapping indexes map, based on the obtained depth map and on the obtained amplitude image. That is, the generated training data set comprises phase image (depth map) training data and the amplitude image training data. Therefore, at 904, an artificial neural network (see 303 in FIG. 3) is trained with the generated training data set in order to generate a neural network (see CNN 403 in FIG. 4), trained in unwrapping iToF measurements. That is, a neural network that is trained to map the per-pixel depth measurements, received as main input (see 300 in FIG. 3), to the per pixel wrapping indexes (see 304 in FIG. 3).

In the embodiment of FIG. 9, the true distance image is obtained from a LIDAR scanner. The LIDAR scanner determines the true distance of an object to the scene by scanning the scene with directed laser pulses. The LIDAR sensor measures the time between emission and return of the laser pulse and calculates the distance between sensor and object. As the LIDAR technique does not rely on phase measurements, it is not affected be the wrapping ambiguity. In addition, due to directivity of LIDAR laser pulses as compared to iToF the laser pulses of a LIDAR scanner hitting an object have a higher intensity than in the case of iToF so that the LIDAR scanner has a larger operating range than the iToF camera. A LIDAR scanner can thus be used to acquire precise true distance measurements (901 in FIG. 9) which can be used as reference data for training a CNN as described in FIG. 9.

Typically, the LIDAR scanner generates point clouds with higher resolution than the iToF camera. Therefore, when generating the training data (903 in FIG. 9), the LIDAR image resolutions are scaled to the iToF image resolutions.

To perform learning, the CNN uses a stream of depth maps (obtained at 900 in FIG. 9) and respective wrapping indexes (obtained at 902 in FIG. 9). In the training data, a depth map and an amplitude image are mapped to a respective map of wrapping indexes. During training (904 in FIG. 9), these mappings are learned by the neural network and, after training, can then be used in the classification process by the neural network. The training phase can be realized by the known method of back-propagation by which the neural network adjusts its weight parameters to the available training data to learn the mapping.

By this training process, the CNN is trained to recognize patterns that correspond to wrapping in the depth map or phase images, to extract features from the denoised phase image that correspond to wrapping regions, and to map them to changes in the wrapping indexes. In order to do so, the training goes through the samples in the acquired dataset, such as the phase image training data and the amplitude image training data and/or the RGB image training data.

In this training process, the CNN will essentially extract: from the phase image the spatial features that correspond to wrapping in the measurements; from the amplitude image, a relation between the received infrared signal intensity (which depends on the unwrapped depth) and the unwrapped depth, as well as object boundaries which will be visible in the amplitude image; from the RGB image (or its pre-processed version, e.g., by segmentation) the object boundaries. The extracted object boundaries may be used and learned by the artificial neural network, for example, to establish spatial neighborhood relations.

FIG. 10 shows a flow diagram visualizing a method for training a neural network, such as the CNN 403 described in FIG. 4, wherein an iToF simulator is used. The CNN 403, in order to generate the wrapping indexes 304, is trained unwrapping iToF measurements, such that at 1000, a depth map (see 400 in FIG. 4) and an amplitude image (see 401 in FIG. 4) of a virtual scene are first obtained with a virtual ToF camera, and then, true distance image is obtained at 1001 based on the position and orientation of the virtual iToF camera and the virtual scene, in order to determine, at 1002, a wrapping indexes map (see 304 in FIGS. 3 and 4) by the integer part results from dividing the respective true distances of the true distance image by the unambiguous range of the virtual iToF camera. At 1003, a training data set is generated based on the determined wrapping indexes map, based on the obtained depth map and the obtained amplitude image. That is, the generated training data set comprises phase image (depth map) training data and the amplitude image training data. Therefore, at 1004, an artificial neural network is trained with the generated training data set in order to generate a neural network, such as the CNN 403, trained in unwrapping iToF measurements.

In the embodiment of FIG. 10, a depth map and an amplitude image of a virtual scene is captured by a virtual iToF camera. The virtual iToF camera is a virtual camera implemented by a ToF simulation program. The ToF simulation program comprises model of a scene that consists of different virtual objects, such as a wall, a floor, a table, a chair, etc. The iToF simulation model is used to generate depth maps and amplitude images of a virtual scene (1000 in FIG. 10). To this end the iToF simulation model simulates the process of an iToF camera, such that operation of camera parameters is performed, and synthetic sensor data is generated in real-time. The iToF simulated data realistically reproduces typical sensor data properties such as motion artifacts, and noise behavior, manipulation of camera parameters and the generation of synthetic sensor data in real-time.

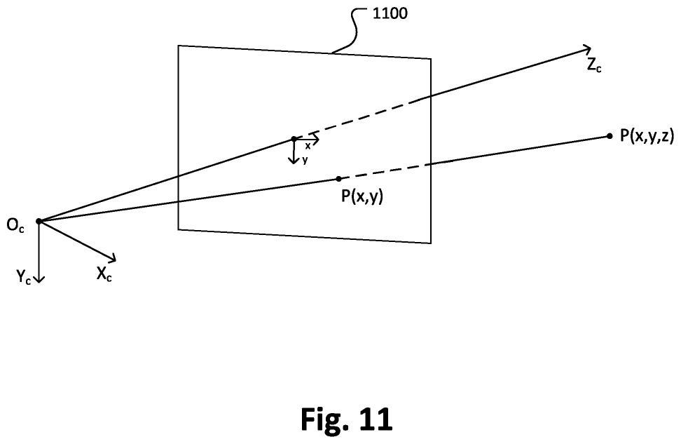

The virtual scene and parameters of the simulated iToF camera such as camera position and location are used to compute the true distance image (1001 of FIG. 10) as described below in FIG. 11 in more detail.

FIG. 11 schematically shows the location and orientation of a virtual iToF camera in a virtual scene. The simulation model locates the virtual iToF camera on a predetermined position O_{c}, in the scene, wherein the point O_{c}, represents the center of projection of the virtual iToF camera. X_{c}, Y_{c}, and Z_{c}, define the camera coordinate system. A virtual image plane 1100 is located perpendicular to the Z_{c} direction. x and y indicate the image coordinate system.

For each pixel P (x, y) in the virtual image plane 1100, a respective true distance can be obtained from the model as follows:

The position P(x,y) of the pixel and the center of projection O_{c} define an optical beam. This optical beam for pixel P(x, y) is checked for intersections with the virtual scene. Here, the optical beam for pixel P(x, y) hits a virtual an object of the virtual scene at position P (x, y, z). The distance between this position P (x, y, z) and the center of projection O_{c} provides the true distance of the object at position P(x, y, z).

By performing this process for all pixels of the virtual iToF sensor, a true distance image of the virtual scene can be generated. By dividing (1002 in FIG. 10) the respective true distances of the true distance image by the unambiguous range of the virtual iToF camera a wrapping indexes map (see 304 in FIGS. 3 and 4) is obtained.

### Implementation

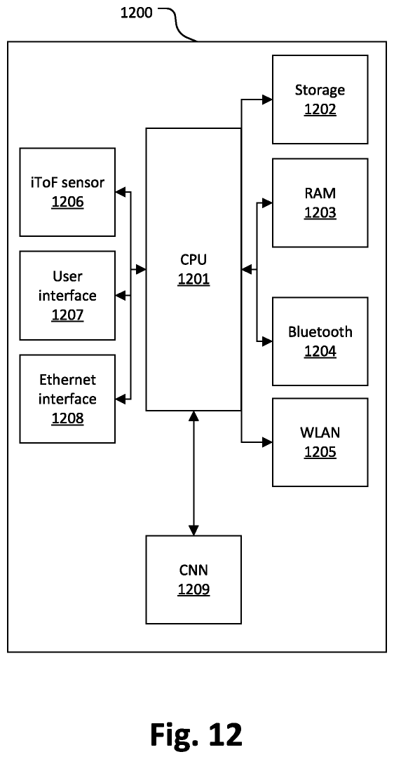

FIG. 12 schematically describes an embodiment of an iToF device that can implement the processes of unwrapping iToF measurements, as described above. The electronic device 1200 comprises a CPU 1201 as processor. The electronic device 1200 further comprises an iToF sensor 1206, a and a convolutional neural network unit 1209 that are connected to the processor 1201. The processor to 1201 may for example implement a pre-processing 302, post-processing 305, denoising 402 and an unwrapping 404 that realize the processes described with regard to FIG. 3, FIG. 4 and FIG. 6 in more detail. The CNN 1209 may for example be an artificial neural network in hardware, e.g. a neural network on GPUs or any other hardware specialized for the purpose of implementing an artificial neural network. The CNN 1209 may thus be an algorithmic accelerator that makes it possible to use the technique in real-time, e.g., a neural network accelerator. The CNN 1209 may for example implement an artificial intelligence (AI) 303, a CNN of U-Net type 403 and a CNN 700 that realize the processes described with regard to FIG. 3, FIG. 4, FIG. 6 and FIG. 7 in more detail. The electronic device 1200 further comprises a user interface 1207 that is connected to the processor 1201. This user interface 1207 acts as a man-machine interface and enables a dialogue between an administrator and the electronic system. For example, an administrator may make configurations to the system using this user interface 1207. The electronic device 1200 further comprises a Bluetooth interface 1204, a WLAN interface 1205, and an Ethernet interface 1208. These units 1204, 1205 act as I/O interfaces for data communication with external devices. For example, video cameras with Ethernet, WLAN or Bluetooth connection may be coupled to the processor 1201 via these interfaces 1204, 1205, and 1208. The electronic device 1200 further comprises a data storage 1202 and a data memory 1203 (here a RAM). The data storage 1202 is arranged as a long-term storage, e.g. for storing the algorithm parameters for one or more use-cases, for recording iToF sensor data obtained from the iToF sensor 1206 and provided to from the CNN 1209, and the like. The data memory 1203 is arranged to temporarily store or cache data or computer instructions for processing by the processor 1201.

It should be noted that the description above is only an example configuration. Alternative configurations may be implemented with additional or other sensors, storage devices, interfaces, or the like.

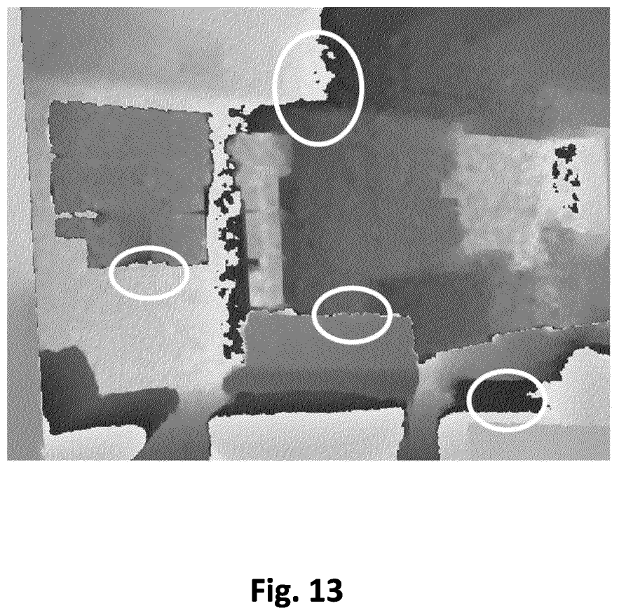

FIG. 13 illustrates an example of a depth map captured by an iToF camera. The depth map of FIG. 13 is an actual depth map including distinctive patterns indicative of the “wrapping” problem described herein. These distinctive patterns in the actual depth map, which are marked by the white circles in FIG. 13, correspond to sharp discontinuities in the phase image. These discontinuities typically occur in the presence of slopes and objects, such as tilted walls or planes in indoor environments, whose depth extends over the unambiguous range of the iToF camera.

The “wrapping” problem usually occurs at similar distances and with a certain self-similarity in the image. For example, the neighbors of a pixel may have the same wrapping index, except in those regions close to a multiple of the unambiguous range.

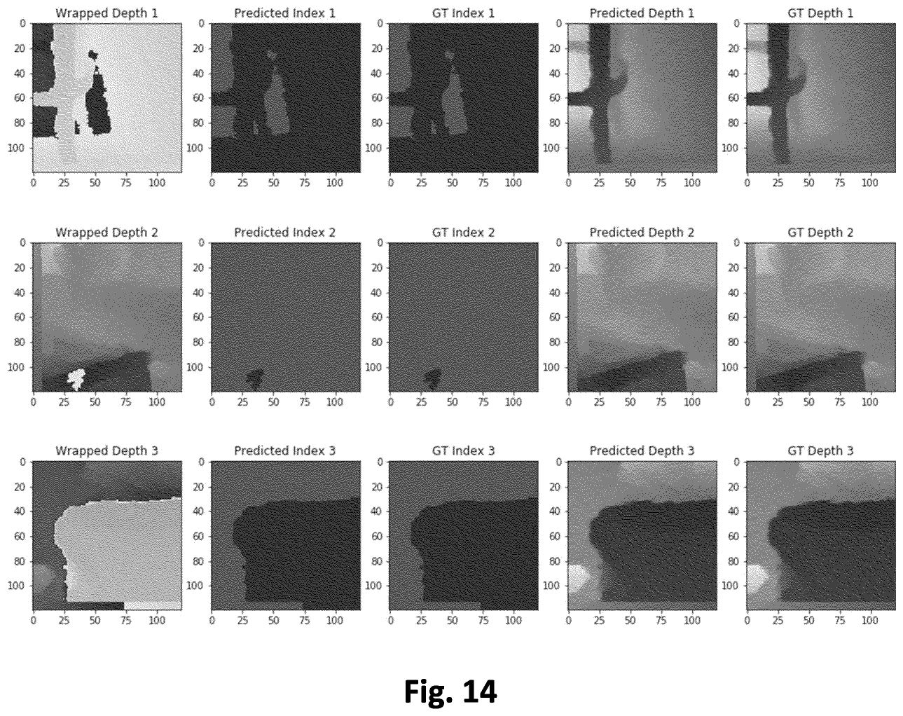

FIG. 14 illustrates an example of different parts of a depth map used as an input to a neural network, together with its output, such as a respective wrapping index and unwrapped depth map. The Wrapped Depth 1, Wrapped Depth 2, and Wrapped Depth 3, shown in FIG. 14, are three different parts of the same depth map. The depth map is the main input to the convolutional neural network and an amplitude image is a side information input, as described in the embodiments herein. Therefore, the CNN output respective wrapping indexes for the three different parts of the depth map, that is the Predicted Index 1 and Predicted Index 2, Predicted Index 3. These predicted wrapping indexes, by simple operations, are converted into Ground Truth (GT) Index 1, GT Index 2 and GT

Index 3, and then, into Predicted Depth 1, Predicted Depth 2, and Predicted Depth 3, respectively. The predicted depth is a very close approximation of the ground truth (GT) depth, such as GT Depth 1, GT Depth 2 and GT Depth 3, shown in FIG. 14.

It should be recognized that the embodiments describe methods with an exemplary ordering of method steps. The specific ordering of method steps is, however, given for illustrative purposes only and should not be construed as binding.

It should also be noted that the division of the electronic device of FIG. 12 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An electronic device comprising circuitry configured to unwrap a depth map (400) or phase image by means of an artificial intelligence algorithm (303; 403; 700) to obtain an unwrapped depth map (306).

(2) The electronic device of (1), wherein the artificial intelligence algorithm (303; 403; 700) is configured to determine wrapping indexes (304) from the depth map (400) or phase image in order to obtain an unwrapped depth map (306).

(3) The electronic device of (1) or (2), wherein the circuitry is configured to perform unwrapping (404) based on the wrapping indexes (304) and an unambiguous operating range of an indirect Time-of-Flight (iToF) camera to obtain the unwrapped depth map (306).

(4) The electronic device of anyone of (1) to (3), wherein the depth map (400) or phase image is obtained by an iToF camera.

(5) The electronic device of anyone of (1) to (4), wherein the artificial intelligence algorithm (303; 403; 700) further uses side-information (301) to obtain an unwrapped depth map (306).

(6) The electronic device of (5), wherein the side-information (301) is an amplitude image (401) obtained by the iToF camera.

(7) The electronic device of (5), wherein the side-information (301) is obtained by one or more other sensing modalities.

(8) The electronic device of (5) or (7), wherein the side information is a color image.

(9) The electronic device of anyone of (1) to (8), wherein the electronic device comprises an iToF camera.

(10) The electronic device of anyone of (1) to (9), wherein the artificial intelligence algorithm (303; 403; 700) is applied on a stream of depth maps and/or amplitude images.

(11) The electronic device of anyone of (1) to (10), wherein the circuitry is further configured to perform pre-processing (302) on the depth map (400) or phase image.

(12) The electronic device of (5), wherein the circuitry is further configured to perform pre-processing (302) on the side information (301).

(13) The electronic device of (11) or (12), wherein the pre-processing comprising segmentation (405), colorspace changes, denoising (402), normalization, filtering, and/or contrast enhancement.

(14) The electronic device of (13), wherein the pre-processing (302) on the side information (301) comprising performing colorspace changes, image segmentation on a color image, or applying color or contrast equalization to an amplitude image.

(15) The electronic device of anyone of (1) to (14), wherein the artificial intelligence algorithm (303; 403; 700) is implemented as an artificial neural network.

(16) The electronic device of (15), wherein the artificial neural network (303; 403; 700) is a convolutional neural network (403; 700).

(17) The electronic device of (16), wherein the convolutional neural network (403; 700) is a convolutional neural network of U-Net type (403).

(18) The electronic device of anyone of (1) to (17), wherein the artificial intelligence algorithm (303; 403; 700) is trained with reference data obtained by a ground truth device.

(19) The electronic device of (18), wherein the ground truth device is a LIDAR scanner.

(20) The electronic device of anyone of (1) to (19), wherein the artificial intelligence algorithm (303; 403; 700) is trained with reference data obtained by an iToF simulation.

(21) A method comprising unwrapping a depth map (400) or phase image by means of artificial intelligence (303; 403; 700) in order to obtain an unwrapped depth map (306).

(22) A training method for an artificial intelligence (303; 403; 700), comprising: obtaining (900; 1000) depth map and amplitude image from an iToF camera;
obtaining (901; 1001) true distance image;
determining (902; 1002) wrapping indexes map based on respective true distances of the true distance image and the unambiguous range of the iToF camera;
generating (903; 1003) training data set based on the wrapping indexes map, the depth map and the amplitude image;
training (904; 1004) an artificial neural network with the training data set to generate a neural network trained in unwrapping iToF measurements.

(23) A method of generating an artificial intelligence (303; 403; 700), comprising . . . obtaining (900; 1000) depth map and amplitude image from an iToF camera;
obtaining (901; 1001) true distance image;
determining (902; 1002) wrapping indexes map based on respective true distances of the true distance image and the unambiguous range of the iToF camera;
generating (903; 1003) training data set based on the wrapping indexes map, the depth map and the amplitude image;
training (904; 1004) an artificial neural network with the training data set to generate a neural network trained in unwrapping iToF measurements.

(24) A method of generating an unwrapped depth map (306), comprising:
obtaining (800) a depth map from an iToF camera; obtaining (801) an amplitude image from the iToF camera;
performing (802) denoising on the depth map and the amplitude image to obtain denoised depth map and denoised amplitude image;
apply (803) an artificial neural network on the denoised depth map and the denoised amplitude image to obtain wrapping indexes;
performing (804) unwrapping based on the wrapping indexes to obtain an unwrapped depth map.

1. An electronic device comprising circuitry configured to unwrap a depth map or phase image by means of an artificial intelligence algorithm to obtain an unwrapped depth map.

2. The electronic device of claim 1, wherein the artificial intelligence algorithm is configured to determine wrapping indexes from the depth map or phase image in order to obtain an unwrapped depth map.

3. The electronic device of claim 1, wherein the circuitry is configured to perform unwrapping based on the wrapping indexes and an unambiguous operating range of an indirect Time-of-Flight (iToF) camera to obtain the unwrapped depth map.

4. The electronic device of claim 1, wherein the depth map or phase image is obtained by an indirect Time-of-Flight (iToF) camera.

5. The electronic device of claim 1, wherein the artificial intelligence algorithm further uses side-information to obtain an unwrapped depth map.

6. The electronic device of claim 5, wherein the side-information is an amplitude image obtained by the iToF camera.

7. The electronic device of claim 5, wherein the side-information is obtained by one or more other sensing modalities.

8. The electronic device of claim 5, wherein the side information is a color image.

9. The electronic device of claim 1, wherein the electronic device comprises an iToF camera.

10. The electronic device of claim 1, wherein the artificial intelligence is applied on a stream of depth maps and/or amplitude images.

11. The electronic device of claim 1, wherein the circuitry is further configured to perform pre-processing on the depth map or phase image.

12. The electronic device of claim 5, wherein the circuitry is further configured to perform pre-processing on the side information.

13. The electronic device of claim 11, wherein the pre-processing comprising segmentation, colorspace changes, denoising, normalization, filtering, and/or contrast enhancement.

14. The electronic device of claim 13, wherein the pre-processing on the side information comprising performing colorspace changes, image segmentation on a color image, or applying color or contrast equalization to an amplitude image.

15. The electronic device of claim 1, wherein the artificial intelligence algorithm is implemented as an artificial neural network.

16. The electronic device of claim 15, wherein the artificial neural network is a convolutional neural network.

17.-18. (canceled)

19. The electronic device of claim 18, wherein the ground truth device is a LIDAR scanner.

20. The electronic device of claim 1, wherein the artificial intelligence algorithm is trained with reference data obtained by an iToF simulation.

21. A method comprising unwrapping a depth map or phase image by means of artificial intelligence circuitry in order to obtain an unwrapped depth map.

22.-23. (canceled)

24. A method of generating an unwrapped depth map, comprising:
obtaining a depth map from an iToF camera;
obtaining an amplitude image from the iToF camera;
performing denoising on the depth map and the amplitude image to obtain denoised depth map and denoised amplitude image;
apply, by circuitry an artificial neural network on the denoised depth map and the denoised amplitude image to obtain wrapping indexes;
performing unwrapping based on the wrapping indexes to obtain an unwrapped depth map.
